(19) United States
(12) Patent Application Publication
(10) Pub. No.: US 2014/0064546 A1
(43) Pub. Date: Mar. 6, 2014

(54) MICROPHONE ASSEMBLY

(71) Applicants: John B. Szczech, Schaumburg, IL (US); Gregory B. Servis, Bloomingdale, IL (US); Peter Van Kessel, Downers Grove, IL (US); Peter V. Loeppert, Durand, IL (US)

(72) Inventors: John B. Szczech, Schaumburg, IL (US); Gregory B. Servis, Bloomingdale, IL (US); Peter Van Kessel, Downers Grove, IL (US); Peter V. Loeppert, Durand, IL (US)

(73) Assignee: KNOWLES ELECTRONICS, LLC, Itasca, IL (US)

(21) Appl. No.: 13/954,223

(22) Filed: Jul. 30, 2013

Related U.S. Application Data
(60) Provisional application No. 61/678,192, filed on Aug. 1, 2012.

(51) Int. Cl. H04R 1/04

(52) U.S. Cl. CPC H04R 1/04
USPC 381/361

(57) ABSTRACT

A microphone assembly includes a cover, a substrate, at least one wall disposed and between and attached to the cover and the substrate, an acoustic transducer acoustically sealed to the lid, and an interposer. The interposer and the acoustic transducer are electrically connected without using the lid as an electrical conduit. The transducer and interposer are disposed one above the other and the transducer is supported by the interposer or by a pedestal.

### CROSS REFERENCE TO RELATED APPLICATION

This patent claims benefit under 35 U.S.C. §119 (e) to U.S. Provisional Application No. 61/678,192 entitled “Microphone Assembly” filed Aug. 1, 2012, the content of which is incorporated herein by reference in its entirety.

### TECHNICAL FIELD

This application relates to the acoustic devices and more specifically to the components that are used in these devices.

### BACKGROUND OF THE INVENTION

Various types of acoustic devices have been used over the years. One example of an acoustic device is a microphone. Generally speaking, a microphone converts sound waves into an electrical signal. Microphones sometimes include multiple components that include micro-electro-mechanical systems (MEMS) and integrated circuits (e.g., application specific integrated circuits (ASICs)).

When used, the MEMS devices and integrated circuits must be secured within the microphone assembly. For instance, these devices are often secured directly to a printed circuit board (PCB) surface at the base of the microphone assemble. In this case, wire bonds used to electrically couple these circuits to other conductors on the opposite or external surface of the PCB base so that these devices can be coupled to other devices, for example, other circuits of a consumer electronic device (e.g., hearing aid, personal computer, or cellular telephone). Wire bonding both the MEMS device and the integrated circuit to the base typically requires a large footprint as the wire bond pads must be spaced a sufficient distance for a capillary to clear the edge of the MEMS device. Although this orientation is often desirable for bottom port microphones (since the front volume to back volume ratio is small), it is less than ideal for top port microphones as the front volume to back volume ratio is large.

Yet another approach is to use flip chip techniques using Gold-to-Gold Interconnection (GGI) bonding methods that mount the MEMS device directly to the port. Unfortunately, various disadvantages with this approach exist including: (1) both front and back volume are typically reduced; (2) high parasitic connection typically exists between the MEMS device and the integrated circuit (e.g., an ASIC); and (3) this approach typically requires the use of expensive High Temperature Co-fired Ceramics (HTCC) substrates.

Because of the various disadvantages described above, user dissatisfaction exists with previous approaches.

### BRIEF DESCRIPTION OF THE DRAWINGS

For a more complete understanding of the disclosure, reference should be made to the following detailed description and accompanying drawings wherein:

FIG. 1 comprises a isometric view of a microphone assembly with no pedestal according to various embodiments of the present invention;

FIG. 2 comprises a cross sectional view of a microphone assembly of FIG. 1 along line A-A according to various embodiments of the present invention;

FIG. 3 comprises a isometric view of a microphone assembly (including a tube) with no pedestal according to various embodiments of the present invention;

FIG. 4 comprises a cross sectional view of a microphone assembly of FIG. 3 along line A-A according to various embodiments of the present invention;

FIG. 5 comprises a isometric view of a microphone assembly (including a tubing) with no pedestal according to various embodiments of the present invention;

FIG. 6 comprises a cross sectional view of a microphone assembly of FIG. 5 along line A-A according to various embodiments of the present invention;

FIG. 7 comprises a isometric view of a microphone assembly (including a grommet) with no pedestal according to various embodiments of the present invention;

FIG. 8 comprises a cross sectional view of a microphone assembly of FIG. 7 along line A-A according to various embodiments of the present invention;

FIG. 9 comprises a isometric view of a microphone assembly (including a surrounding gasket) with no pedestal according to various embodiments of the present invention;

FIG. 10 comprises a cross sectional view of a microphone assembly of FIG. 9 along line A-A according to various embodiments of the present invention;

FIG. 11 comprises a isometric view of a microphone assembly (including a non-surrounding gasket) with no pedestal according to various embodiments of the present invention;

FIG. 12 comprises a cross sectional view of a microphone assembly of FIG. 11 along line A-A according to various embodiments of the present invention;

FIG. 13 comprises a isometric view of a microphone assembly with a pedestal according to various embodiments of the present invention;

FIG. 14 comprises a cross sectional view of a microphone assembly of FIG. 13 along line A-A according to various embodiments of the present invention;

FIG. 15 comprises a isometric view of a microphone assembly with a pedestal according to various embodiments of the present invention;

FIG. 16 comprises a cross sectional view of a microphone assembly of FIG. 15 along line A-A according to various embodiments of the present invention;

FIG. 17 comprises a isometric view of a microphone assembly with a pedestal according to various embodiments of the present invention;

FIG. 18 comprises a cross sectional view of a microphone assembly of FIG. 17 along line A-A according to various embodiments of the present invention;

FIG. 19 comprises a isometric view of a microphone assembly with a pedestal according to various embodiments of the present invention;

FIG. 20 comprises a cross sectional view of a microphone assembly of FIG. 19 along line A-A according to various embodiments of the present invention;

FIG. 21 comprises a isometric view of a microphone assembly with a pedestal according to various embodiments of the present invention;

FIG. 22 comprises a cross sectional view of a microphone assembly of FIG. 21 along line A-A according to various embodiments of the present invention;

FIG. 23 comprises a isometric view of a microphone assembly with a pedestal according to various embodiments of the present invention;

FIG. 24 comprises a cross sectional view of a microphone assembly of FIG. 23 along line A-A according to various embodiments of the present invention;

FIG. 25 comprises a isometric view of a microphone assembly with a pedestal according to various embodiments of the present invention;

FIG. 26 comprises a cross sectional view of a microphone assembly of FIG. 25 along line A-A according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

In the approaches described herein, microphones (e.g., wideband microphones having a “flat” response characteristics out to approximately 20 kHz, meaning less than approximately +/−5 dB variation out to approximately 20 kHz) in a top port configuration are provided with these microphones having desirable sensitivity characteristics. For example, the approaches described herein provide microphones having a resonance peak equal to or exceeding that of previous bottom port microphones. Moreover, the sensitivity responses for the top port microphones provided herein are similar to the desirable sensitivity characteristics provided by bottom port microphones. The approaches described herein also provide for small assemblies (e.g., with assembly dimensions of approximately 3.76×2.95×1.13 mm or less to take one specific example).

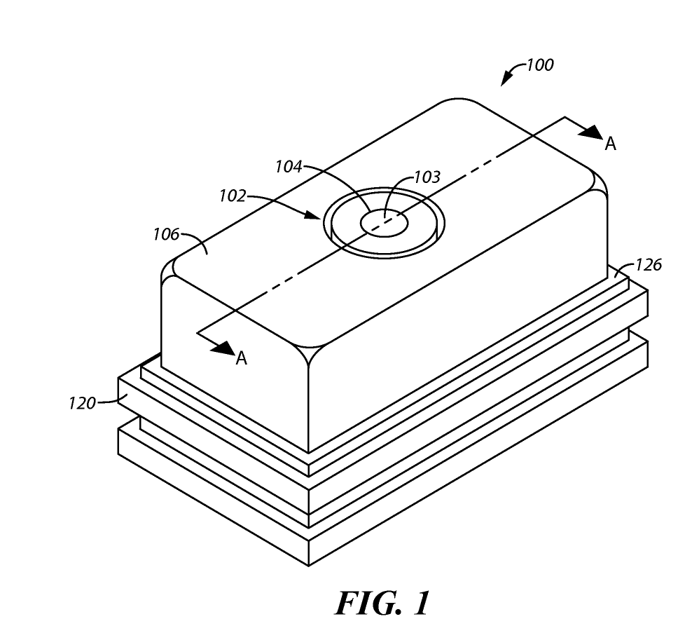

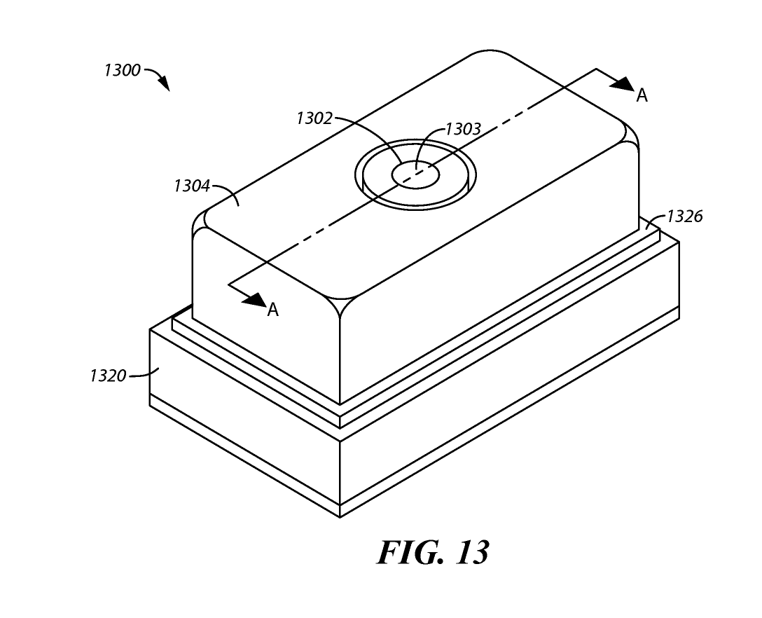

In some aspects, approaches are provided that utilize multiple and different chip attachment techniques (e.g., wire bonding, surface mounting, embedding the integrated circuit into the substrate or base, and GGI to mention a few examples) to facilitate the direct attachment of MEMS devices to a housing (e.g., a metal can lid). Various microphone assemblies are provided with some approaches using GGI/wire bonding assembly techniques for assembly and other approaches using GGI/surface mount/wire bonding techniques for assembly. In one aspect, the assemblies described in FIGS. 1-12 utilize GGI and wire bonding while the assemblies of FIGS. 13-24 use GGI and solder approaches.

In the present approaches, direct GGI of Transducer (MEMs) to Integrated Circuit (ASIC) or pedestal circumvents the requirement to use costly ceramic PCB substrates because the ASIC or pedestal assumes the role of the ceramic substrate (e.g. GGI is performed at the silicon die level). Therefore, the MEMs-ASIC or MEMs-pedestal become a sub-assembly that can be attached to traditional PCB substrates made of, for example, FR-4. The orientation of the MEMs also allows for direct attachment to the acoustic port which is located at the top of the microphone package. Attaching the transducer directly to the acoustic port hole reduces the front volume, which improve wideband operation not possible with previous top port microphones. Further, approaches that use pedestal configuration can provide additional functionality, as the pedestal can be designed in a manner to alter the electrical impedance of the electrical coupling between the MEMs and ASIC.

In many of these embodiments, a microphone assembly includes a lid (or housing), a top port in the housing (lid), and a base. An acoustic transducer (e.g., a MEMS device including a diaphragm and a back plate) and at least one interposer (e.g., an ASIC, integrated circuit, ceramic plate and combinations of these elements) are also provided. The transducer is acoustically sealed to the lid. By “acoustically sealed,” it is meant that the acoustic pressure waves enter and exit the microphone housing through the MEMS diaphragm and back plate. The base is directly electrically coupled to the acoustic transducer without using the lid as an electrical, power, or grounding pathway or conduit (or disposing conduits therein). In other words, the lid is not used as electrical signal, grounding path, or power path. The primary function of the lid is to provide an opening for sound to enter and to shield the components from the elements and electrical magnetic interference. The transducer and ASIC or pedestal are disposed one above the other and the transducer is supported by the ASIC or pedestal.

In others of these embodiments, a microphone assembly includes a cover, a substrate, at least one wall disposed and between and attached to the cover and the substrate, an acoustic transducer acoustically sealed to the lid, and an interposer. The interposer and the acoustic transducer are electrically connected without using the lid as an electrical conduit. The transducer and interposer are disposed one above the other and the transducer is supported by the interposer or by a pedestal.

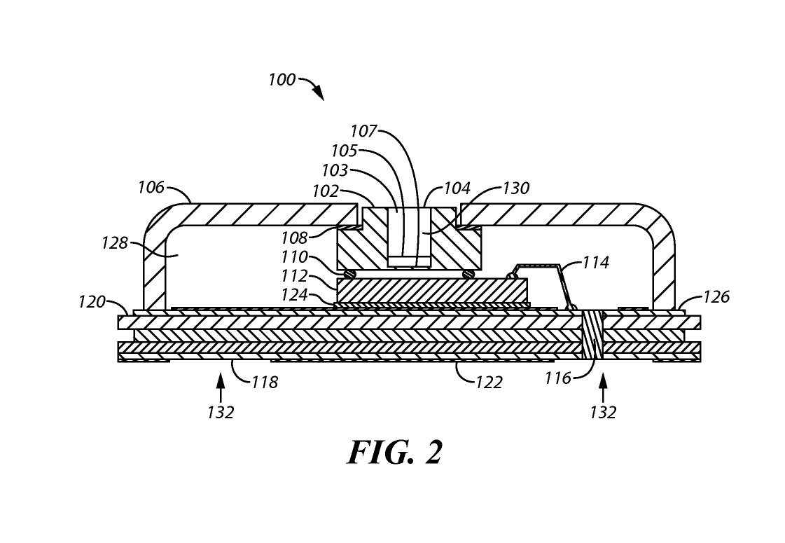

Referring now to FIGS. 1-2, one example of a microphone assembly 100 is described. The microphone assembly 100 includes a transducer 102 with etched nozzle 104; a housing (e.g., a metal can) 106 that includes a top port or opening 103; a seal 108; bumps 110 (e.g., constructed of gold); an integrated circuit 112; a wire bond 114; a filled plate through hole 116; a solder pad 118; a multi-layered base or substrate (e.g., a PCB with embedded passives) 120 (by “passives” it is meant a component that does not need a separate power to operate); a solder mask 122; a die attach 124; an electrically conductive and acoustic seal 126; a back volume 128; and a front volume 130; and conductive customer pads 132.

The transducer 102 is a MEMS device and includes a diaphragm 105 and back plate 107. The purpose of the etched nozzle 104 is to assist in self-alignment of the port in the lid to transducer 102. The etched nozzle 104 extends into the top port 103.

The housing or lid 106 is, in one example, a metal can with the port 103 extending therethrough. The seal 108 provides a seal between the transducer 102 and the housing 106. In one example, the seal is constructed of non-conductive polymer. Other examples of materials may also be used. The integrated circuit 112 may be any type of integrated circuit such as an application specific integrated circuit (ASIC) and may perform any processing function. In the example of FIGS. 1-2, the integrated circuit 112 is the interposer. However, it will be appreciated that other interposers (e.g., an ASIC, ceramic plate) can also be used in pace of or in addition to the integrated circuit 112.

The back volume 128 includes the cavity formed by the housing 106 and is an opening that is bounded by the housing and the back plate 107. The front volume 130 is a space that extends between the opening of port 103 and the diaphragm 105. It is typically advantageous in microphones to minimize the front volume 130 while maximizing the back volume. In one example, an optimum ratio of back volume to front volume is approximately 10. Other ratios are possible.

The transducer 102 is disposed upon bumps 110, which in turn are disposed upon the integrated circuit 112. The bumps 110 provide an electrical connection between the transducer 102 and the integrated circuit 112. It will be appreciated that there is a direct electrical connection between the transducer 102 and the integrated circuit 112 and that the integrated circuit 112 directly and physically supports the transducer 102. In the present configuration, there may be a very small distance between the transducer 102 and the integrated circuit 112 (i.e., having the distance defined by the thickness of the bumps 110), but it will be appreciated that the weight of the transducer 102 is supported by the integrated circuit 112.

The wire bond 114 couples the integrated circuit 112 to conductive traces on the base 120. In this respect, the base 120 may be constructed of multiple layers of conductive and non-conductive materials providing electrical interconnections (e.g., is a printed circuit board (PCB)). A filled plate through hole or opening 116 extends through the base 120. The hole 116 is plated with a conductive material such as copper to provide a conductive electrical path.

A solder pad 118 provides a conductive surface on the bottom of the base 120. An electrical connection exists between the wire bond 114 and the solder pad 118. The solder mask 122 is disposed on the base to provide a non-conductive surface. The exposed areas of the solder pad 118 form conductive pads 132 from which a customer may obtain an electrical connection with the assembly 100. Through the conductive pads 132, a customer can receive signals from the assembly 100 and power and grounding connections can be provided.

The function of the die attach 124 is to secure the integrated circuit 112 to the base 120. In one example, the die attach 124 is constructed of non-conducting polymer. The electrically conductive and acoustic seal 126 provides a seal between the base 120 and the housing 106.

The assembly 100 provides a direct transducer 102-to-integrated circuit 112 connection via the bumps 110. The assembly 100 additionally provides bottom port performance in a top port assembly (e.g., a top port metal can assembly). In this respect, the sensitivity response of the assembly 100 closely matches that of bottom port configurations even though the assembly is a top port configuration. The transducer and integrated circuit can be handled as a sub-assembly. In other words, the transducer and integrated circuit can be picked and placed onto the PBC in one process step. In some previous approaches, the transducer and integrated circuit are placed on the base or substrate separately. Omitting an extra “pick and place” step saves time/money. Additionally, this approach is self-centering with respect to the housing and transducer. By “self-centering,” it is meant that when the housing is placed over the base during assembly, the opening of the housing will center with opening of the transducer.

In one example of the operation of the assembly of FIGS. 1-2, sound energy is received by the transducer 102 via the port 103 and the transducer 102 converts the sound energy into electrical energy. In that respect, the sound energy causes movement of the diaphragm 105 and this varies the electrical potential between the diaphragm 105 and the back plate 107. The current or voltage that is produced by the transducer 102 represents the sound energy that has been received by the transducer 102.

The resultant signal is transmitted from transducer 102 to the integrated circuit 112 via the bumps 110 and is processed by the integrated circuit 112. After processing, the signal is sent from the integrated circuit 112, through wire bond 114, then through the conductive hole 116 to the customer pads 132. A customer may couple other devices to the pads 132 and, in one aspect, further process or utilize the signal. In this respect, the assembly 100 may be disposed in any type of device such as a hearing aid, personal computer, or cellular telephone to mention a few examples.

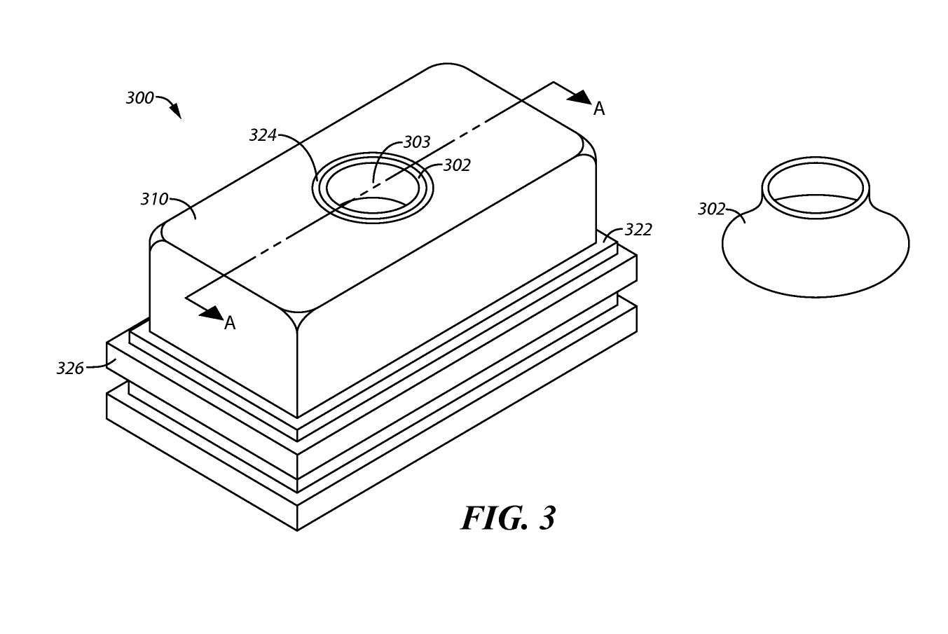

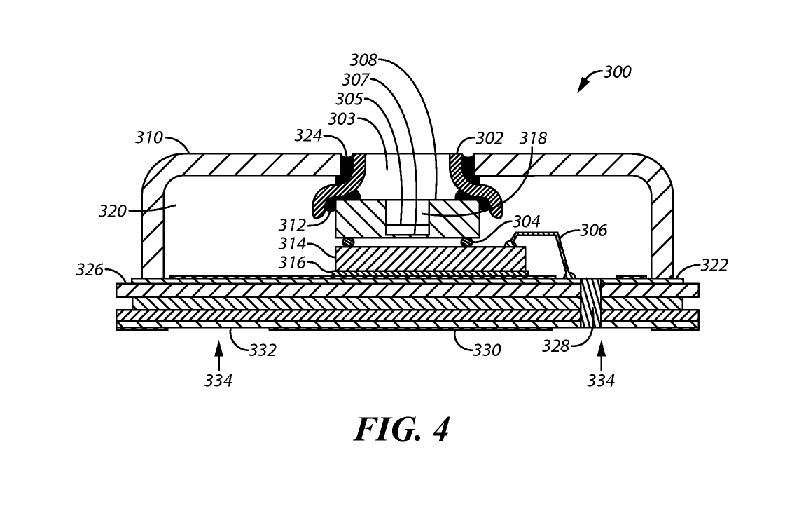

Referring now to FIGS. 3-4, another example of a microphone assembly 300 is described. The microphone assembly 300 includes a nozzle or tube 302; bumps 304 (e.g., constructed of gold); a wire bond 306; a transducer 308 (including a diaphragm 305 and back plate 307); a housing (e.g., a metal can) 310 that includes a top port or opening 303; a sealant 312 (e.g., a viscoelastic sealant such as silicone); an integrated circuit 314; a die attach 316; a front volume 318; a back volume 320; an electrically conductive and acoustic seal 322; a flowable sealant 324 (e.g., non-conductive polymer); a multi-layered base or substrate (e.g., a PCB with embedded passives) 326; a filled plated through hole 328; a solder mask 330; a solder pad 332; and conductive pads 334.

It will be understood that the example of FIGS. 3-4 is similar to the example of FIGS. 1-2 except that the nozzle or tube 302 (e.g., constructed of stamped metal) is used in place of the etched nozzle. The nozzle or tube 302 is sealed with the housing 310 using sealant 312 and with the transducer 308 using flowable sealant 324. By “sealed” it is meant that the acoustic pressure waves enter and exit the microphone housing through the MEMs diaphragm and back plate. Since the components and the operation of these components are similar to those that have already been described, the description of these components and their operation will not be repeated here.

The assembly 300 provides a direct transducer-to-integrated circuit connection. The assembly 300 provides a bottom port performance for a top port assembly (e.g., a top port metal can assembly). The transducer and integrated circuit can be handled as one assembly as described elsewhere herein.

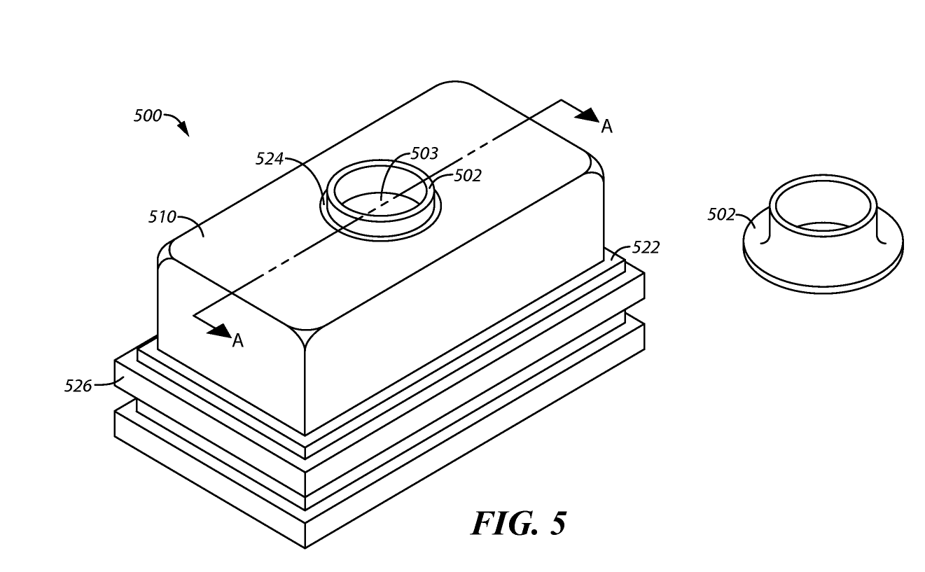

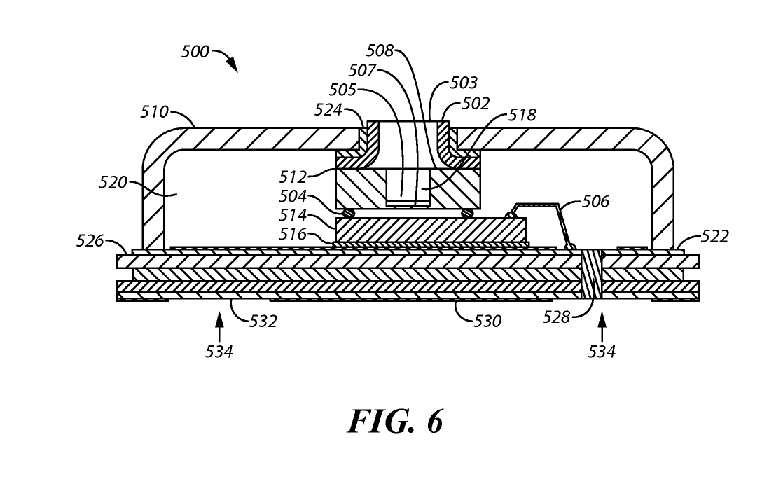

Referring now to FIGS. 5-6, another example of a microphone assembly 500 is described. The microphone assembly 500 includes a nozzle or tube 502; bumps 504 (e.g., constructed of gold); a wire bond 506; a transducer 508 (including a diaphragm 505 and back plate 507); a housing (e.g., a metal can) 510 that includes a top port or opening 503; a sealant 512 (e.g., a viscoelastic sealant such as silicone); an integrated circuit 514; a die attach 516; a front volume 518; a back volume 520; an electrically conductive and acoustic seal 522; solder 524; a multi-layered base or substrate (e.g., a PCB with embedded passives) 526; a filled plated through hole 528; a solder mask 530; a solder pad 532; and conductive pads 534.

It will be understood that the example of FIGS. 5-6 is similar to the example of FIGS. 3-4 except that the nozzle or tube is sealed by solder 524. Since the components and the operation of these components are similar to those that have already been described, the description of these components and their operation will not be repeated here.

The assembly 500 provides a direct transducer to integrated circuit connection. The assembly 500 also provides a bottom port performance for a top port assembly (e.g., a top port metal can assembly).

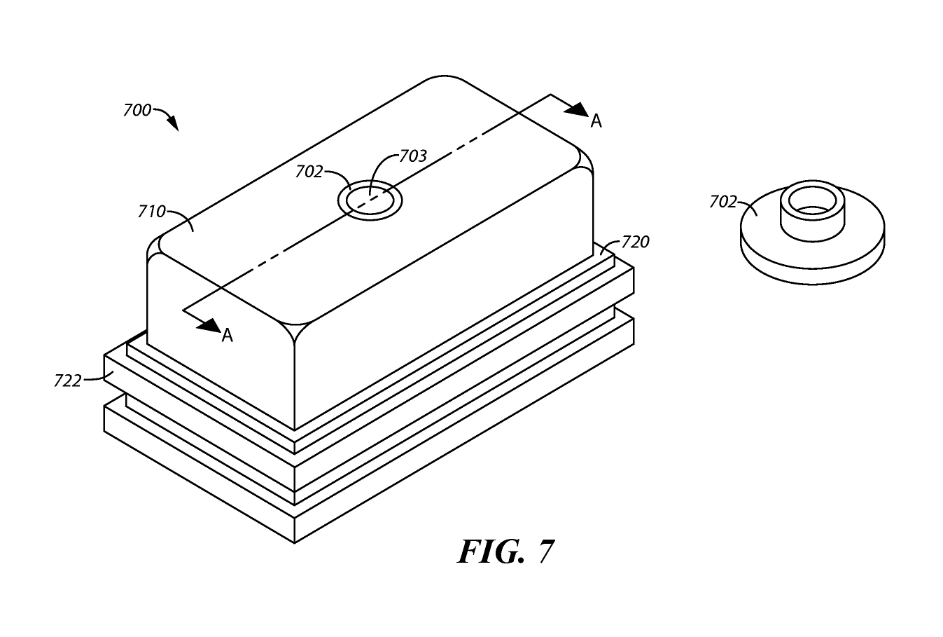

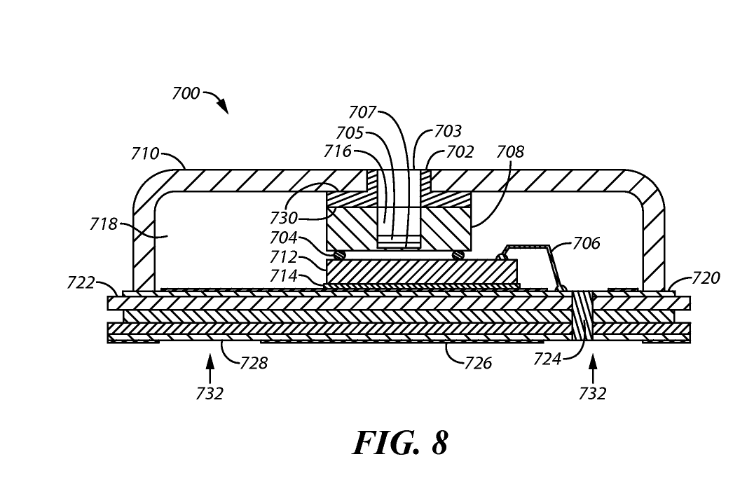

Referring now to FIGS. 7-8, another example of a microphone assembly 700 is described. The microphone assembly 700 includes a grommet 702; bumps (e.g., constructed of gold); a wire bond 706; a transducer 708 (including a diaphragm 705 and back plate 707); a housing (e.g., a metal can) 710 that includes a top port or opening 703; an integrated circuit 712; a die attach 714; a front volume 716; a back volume 718; an electrically conductive and acoustic seal 720; a multi-layered base or substrate (e.g., PCB with embedded passives) 722; a filled plated through hole 724; a solder mask 726; a solder pad 728; a sealant or compression fit 730; and conductive pads 732.

It will be understood that the example of FIGS. 7-8 is similar to the example of FIGS. 5-6 except that a grommet 702 is used instead of a tube. The grommet 702 is a ring that extends into the port 703 and is constructed of molded, low durometer elastomer, such as, silicone in one example. Since the components and the operation of these components are similar to those that have been previously described, the description of these components and their operation will not be repeated here.

The assembly 700 provides a direct transducer to integrated circuit connection. The assembly 700 also provides a bottom port performance in a top port assembly (e.g., a top port metal can assembly). The grommet 702 provides a good transducer to housing seal.

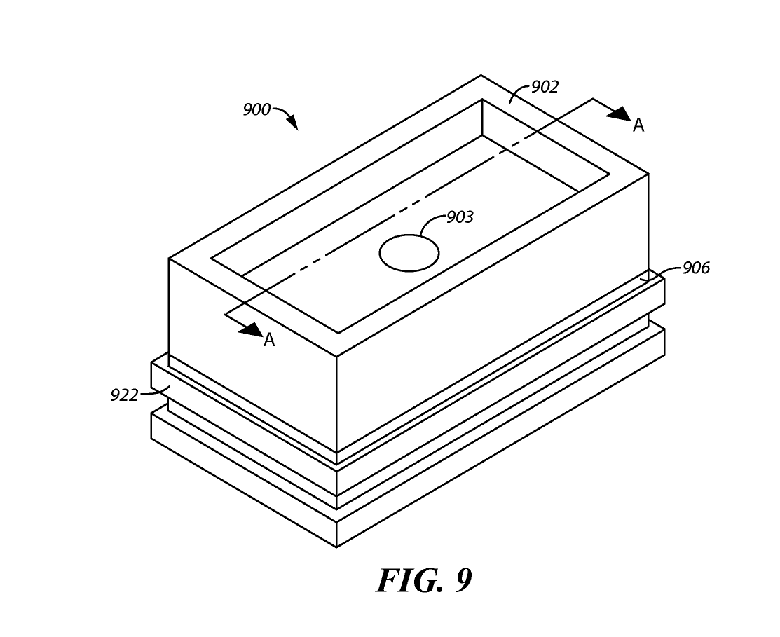

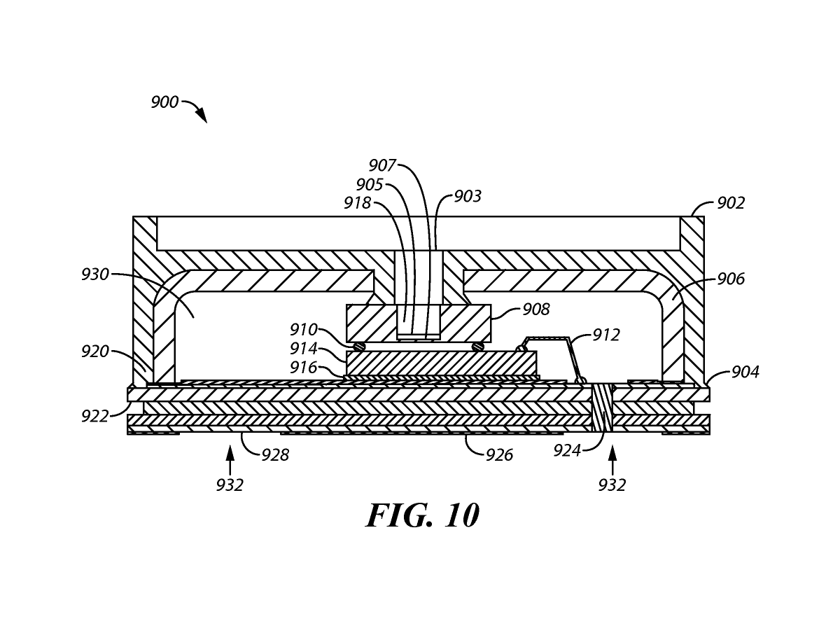

Referring now to FIGS. 9-10, another example of a microphone assembly 900 is described. The microphone assembly 900 includes a gasket 902; adhesive 904; a housing (e.g., a metal can) 906 that includes a top port or opening 903; a transducer 908 (including a diaphragm 905 and back plate 907); bumps 910 (e.g., constructed of gold); a wire bond 912; an integrated circuit 914; a die attach 916; a front volume 918; an electrically conductive and acoustic seal 920; a multi-layered base or substrate (e.g., PCB with embedded passives) 922; a filled plated through hole 924; a solder mask 926; a solder pad 928; a back volume 930; and conductive pads 932.

It will be understood that the example of FIGS. 9-10 is similar to the example of FIGS. 7-8 except that a gasket 902 is used in place of the grommet. By gasket, it is meant shaped piece of material that can provide an acoustic seal when mated to another surface. The gasket extends around the housing 906 and also extends through the port 903. The gasket 902 may be constructed of molded, low durometer elastomer, such as, silicone in one example. The gasket 902 is attached to the housing 906 by Non-conducting polymer. Since the components and the operation of these components are similar to those that have already described elsewhere herein, the description of these components and their operation will not be repeated here.

The assembly 900 provides a direct transducer to integrated circuit connection. The assembly 900 provides a bottom port performance for a top port assembly (e.g., a top port metal can assembly). The assembly provides phone level gasketing solution meaning that the microphone assembly can used without the end user designing and implementing a gasket as typically required with traditional top port microphones.

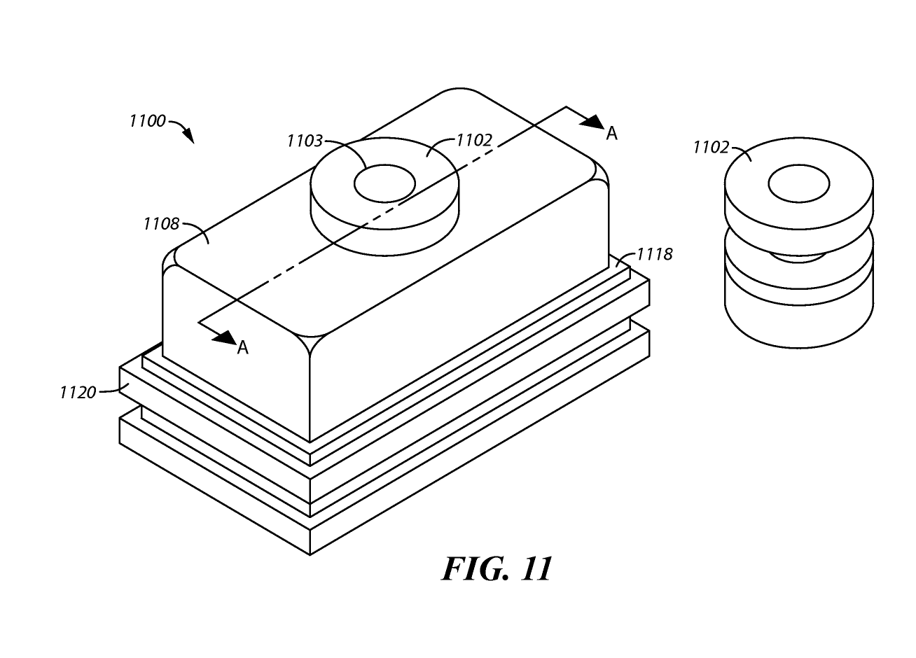

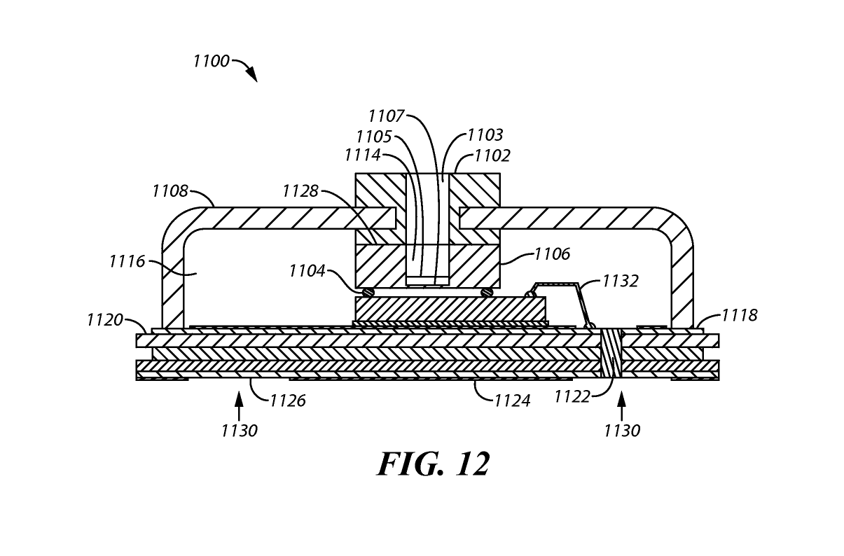

Referring now to FIGS. 11-12, another example of a microphone assembly 1100 is described. The microphone assembly 1100 includes a gasket 1102; bumps 1104 (e.g., constructed of gold); a transducer 1106 (including a diaphragm 1105 and back plate 1107); a housing (e.g., a metal can) 1108 that includes a top port or opening 1103; an integrated circuit 1110; a die attach 1112; a front volume 1114; a back volume 1116; an electrically conductive and acoustic seal 1118; a multi-layered base or substrate (e.g., PCB with embedded passives) 1120; a filled plated through hole 1122; a solder mask 1124; a solder pad 1126; adhesive 1128; conductive pads 1130; and wire bond 1132.

It will be understood that the example of FIGS. 11-12 is similar to the example of FIGS. 9-10 except that a gasket 1102 is used in place of the gasket shown in FIGS. 9-10. The gasket 1102 is different from the gasket shown in FIGS. 9-10 in that the gasket 1102 does not extend around the housing 1108. The gasket 1102 may be constructed of low durometer silicone in one example. The gasket 1102 attaches to the housing 1108 by means of mechanical press fit. Since the components and the operation of these components are similar to those that have already been described elsewhere herein, the description of these components and their operation will not be repeated here.

The assembly 1100 provides a direct transducer to integrated circuit connection. The assembly 1100 provides a bottom port performance in a top port assembly (e.g., a top port metal can assembly). The assembly 1100 provides phone level gasketing approach as has been described above.

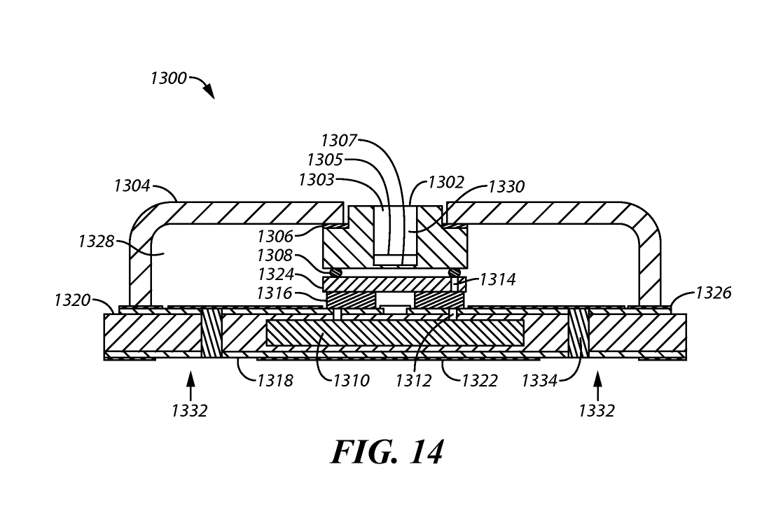

Referring now to FIGS. 13-14, another example of a microphone assembly 1300 is described. The microphone assembly 1300 includes a transducer 1302 (including a diaphragm 1305 and back plate 1307); a housing (e.g., a metal can) 1304 that includes a top port or opening 1303; a seal or gasket 1306; bumps 1308 (e.g., constructed of gold); an integrated circuit 1310; a plated blind hole 1312; filled plate through holes 1314 and 1334; solder 1316; a solder pad 1318; a multi-layered base or substrate (e.g., PCB with embedded passives) 1320; a solder mask 1322; a pedestal (with vertical interconnects) 1324; an electrically conductive and acoustic seal 1326; a back volume 1328; a front volume 1330; and conductive customer pads 1332. The purpose of the blind hole 1312 is to provide a consecutive path through the base 1320 to the integrated circuit 1310.

It will be understood that the example of FIGS. 13-14 is similar to the example of FIGS. 1-2 except that the pedestal 1324 is used in the assembly 1300. In one aspect, the pedestal 1324 is constructed of silicon and includes vertical interconnects (the conductive hole or interconnect 1314). The pedestal 1324 in one example is a single piece of silicon with the conductive vertical passages (interconnects) extending therethrough. The pedestal 1324 can provide additional functionality, as the pedestal 1324 can be designed in a manner to alter the electrical impedance of connection between the transducer and ASIC. In addition and in contrast to the example of FIGS. 1-2, the integrated circuit 1310 is embedded in the base 1320. It will be appreciated that in the examples described herein where the integrated circuit is embedded in the base, that in other arrangements the integrated circuit may be partially embedded in the base. As for the remaining components, since these components and the operation of these components are similar to what has already been described, this description will not be repeated here.

In operation, the signal from the transducer 1302 is transmitted from the transducer 1302, to the bumps 1308, through the through hole 1314 in the pedestal 1324, across solder 1316, through the blind hole 1312 to the integrated circuit 1310 where it is processed. From the integrated circuit 1310, the signal is transmitted through blind holes 1312, through the through hole 1317, and to pads 1332. From the pads 1332, a customer can couple to the assembly 1300.

The assembly 1300 obtained is of very small dimensions (e.g., approximately 2.5×2.5×1.5 mm or less). The assembly 1300 also provides a bottom port performance in a top port assembly (e.g., a top port metal can assembly). As described above, this is a self-centering approach with respect to the transducer and lid or housing.

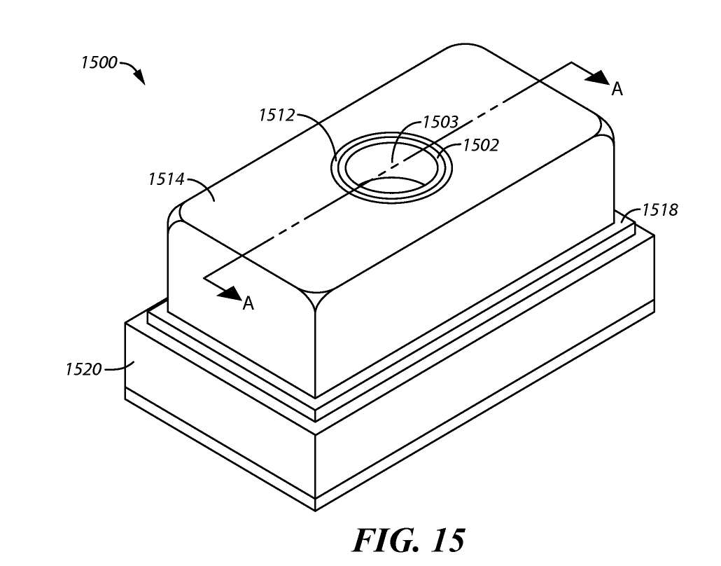

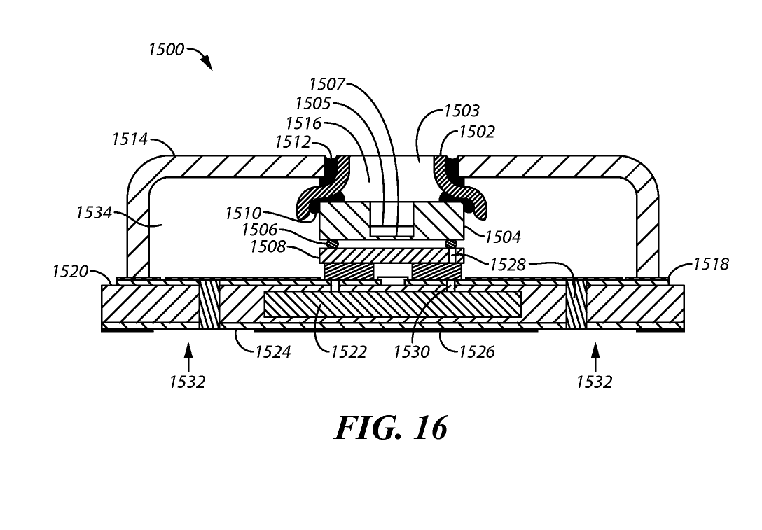

Referring now to FIGS. 15-16, another example of a microphone assembly 1500 is described. The microphone assembly 1500 includes a nozzle or tube 1502, a transducer 1504 (including a diaphragm 1505 and back plate 1507); bumps 1506 (e.g., constructed of gold); a pedestal 1508; solder 1509; a sealant 1510 (e.g., a viscoelastic sealant such as silicone); a flowable sealant 1512 (e.g., non-conducting polymer); a housing (e.g., can) 1514 that includes a top port or opening 1503; a front volume 1516; an electrically conductive and acoustic seal 1518; a multi-layered base or substrate (e.g., PCB with embedded passives) 1520; an integrated circuit 1522; a solder pad 1524; a solder mask 1526; a filled plated through hole 1528; a plated blind hole 1530; conductive pads 1532; and back volume 1534.

It will be understood that the example of FIGS. 15-16 is similar to the example of FIGS. 3-4 but includes the pedestal of FIGS. 13-14 and that the integrated circuit 1522 is disposed within the base 1520. In operation, the signal from the transducer 1504 is transmitted from the transducer 1504, to the bumps 1506, through the through hole 1528 in the pedestal 1508, across solder 1509, through the through hole 1517, and to pads 1532. Since these components and the operation of these components are similar to what has already been described, this description will not be repeated here.

The assembly 1500 provides for very small assemblies (e.g., 2.5×2.5×2.5 mm or less). The assembly 1500 also provides a bottom port performance in a top port assembly (e.g., a top port metal can assembly).

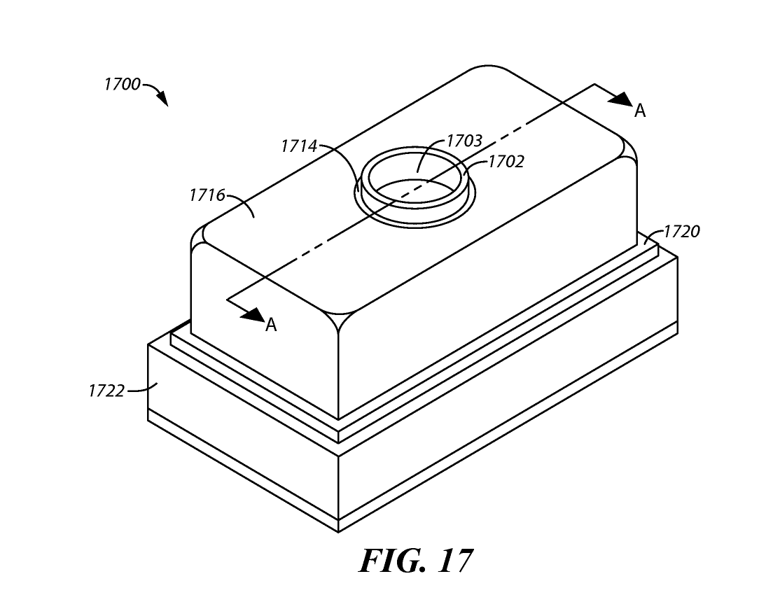

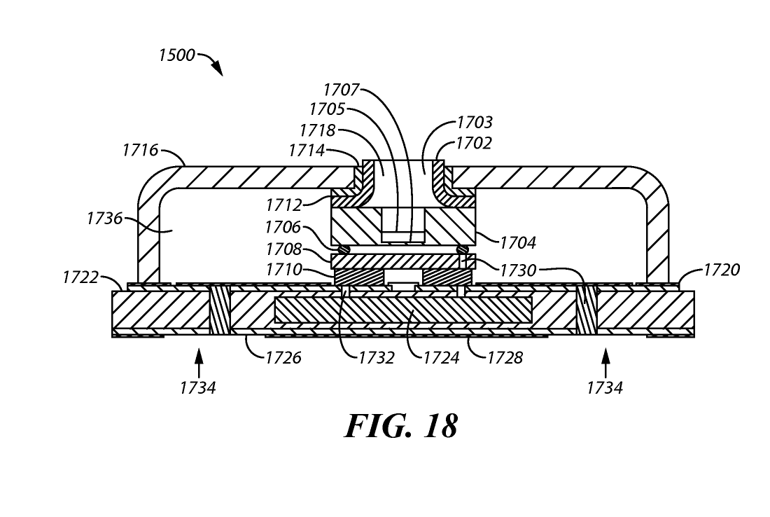

Referring now to FIGS. 17-18, another example of a microphone assembly 1700 is described. The microphone assembly 1700 includes a nozzle or tube 1702; a transducer 1704 (including a diaphragm 1705 and back plate 1707); bumps 1706 (e.g., constructed of gold); a pedestal 1708; solder 1710; sealant 1712; solder or conductive sealant 1714; a housing (e.g., a metal can) 1716 that includes a top port or opening 1703; a front volume 1718; an electrically conductive and acoustic seal 1720; a multi-layered base or substrate (e.g., PCB with embedded passives) 1722; an integrated circuit 1724; a solder pad 1726; a solder mask 1728; a filled plated through hole 1730; a plated blind hole 1732; conductive pads 1734; and back volume 1734.

It will be understood that the example of FIGS. 17-18 is similar to the example of FIGS. 5-6 but includes the pedestal of FIGS. 13-16 and that the integrated circuit 1724 is disposed within the base 1720. Since these components and the operation of these components are similar to what has already been described, this description will not be repeated here.

The assembly 1700 provides for very small assemblies. The assembly 1700 also provides a bottom port performance in a top port assembly (e.g., a top port metal can assembly).

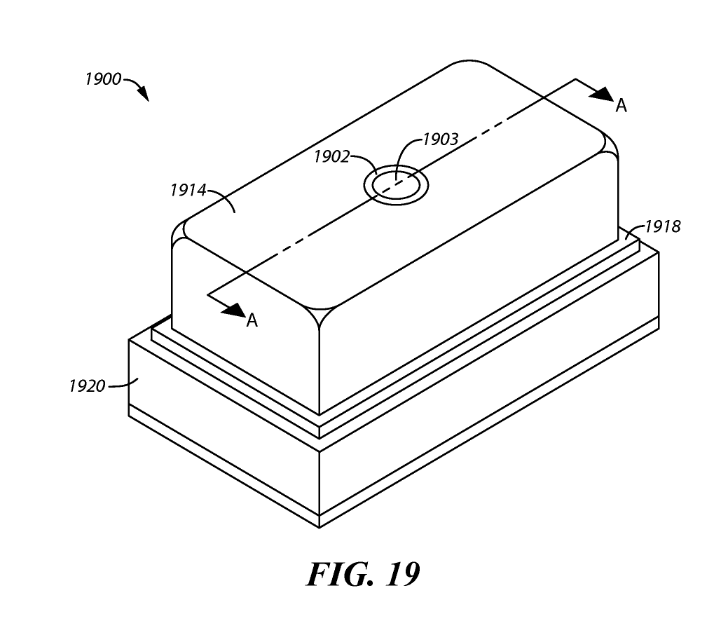

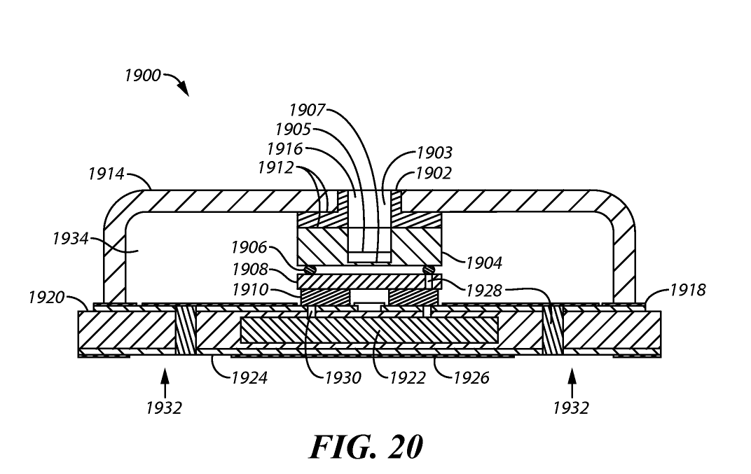

Referring now to FIGS. 19-20, another example of a microphone assembly 1900 is described. The microphone assembly 1900 includes a grommet 1902; a transducer 1904 (including a diaphragm 1905 and back plate 1907); bumps 1906 (e.g., constructed of gold); a pedestal (with vertical interconnects) 1908; solder 1910; sealant or compressive fit 1912; a housing (e.g., a metal can) 1914 that includes a top port or opening 1903; a front volume 1916; an electrically conductive and acoustic seal 1918; a multi-layered base or substrate (e.g., PCB with embedded passives) 1920; an integrated circuit 1922; a solder pad 1924; a solder mask 1926; a filled plated through hole 1928; a plated blind hole 1930; conductive pads 1932; and back volume 1934.

It will be understood that the example of FIGS. 19-20 is similar to the example of FIGS. 7-8 but includes the pedestal of FIGS. 13-18 and that the integrated circuit 1922 is disposed within the base 1920. Since these components and the operation of these components are similar to what has already been described, this description will not be repeated here.

The assembly 1900 provides for very small assemblies (e.g., 2.5×2.5×1.5 mm or less). The assembly 1900 also provides a bottom port performance in a top port assembly (e.g., a top port metal can assembly).

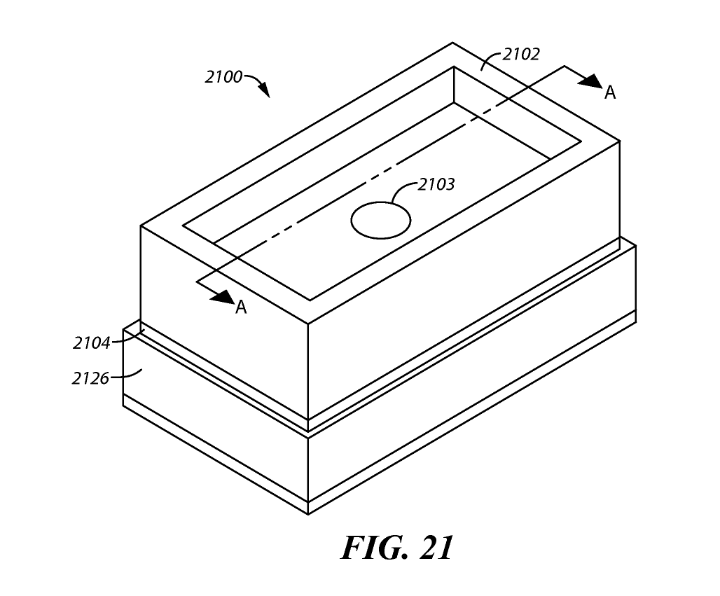

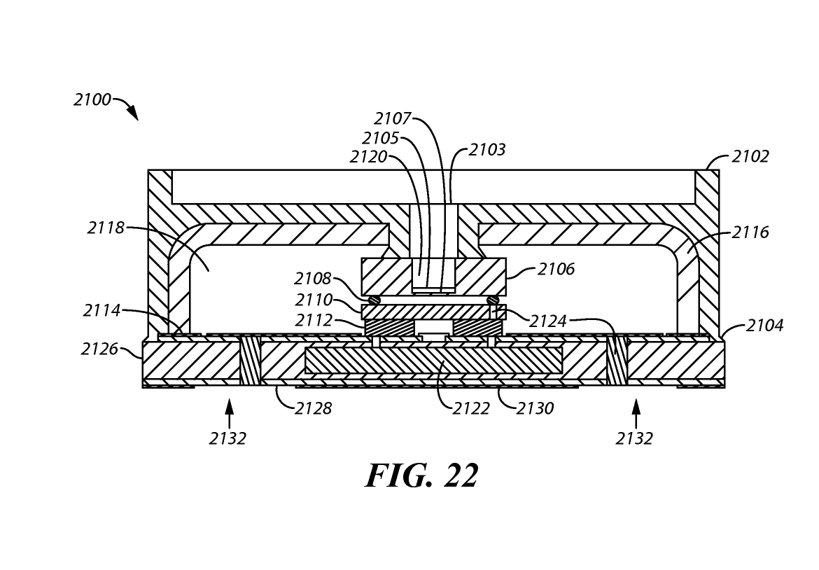

Referring now to FIGS. 21-22, another example of a microphone assembly 2100 is described. The microphone assembly 2100 includes a gasket 2102; adhesive 2104; a transducer 2106 (including a diaphragm 2105 and back plate 2107); bumps 2108 (e.g., constructed of gold); a pedestal 2110; solder 2112; an electrically conductive and acoustic seal 2114; a housing (e.g., a metal can) 2116 that includes a top port or opening 2103; a back volume 2118; affront volume 2120; an integrated circuit 2122; a filled plated through hole 2124; a multi-layered base or substrate (e.g., PCB with embedded passives) 2126 with embedded integrated circuit 2122; a solder pad 2128; a solder mask 2130; and conductive pads 2132.

It will be understood that the example of FIGS. 21-22 is similar to the example of FIGS. 9-10 but includes the pedestal of FIGS. 13-20 and that the integrated circuit 2122 is disposed within the base 2126. Since these components and the operation of these components are similar to what has already been described, this description will not be repeated here.

The assembly 2100 provides for very small assemblies (e.g., 3×3×3 or smaller). The assembly 2100 also provides a bottom port performance in a top port assembly (e.g., a top port metal can assembly).

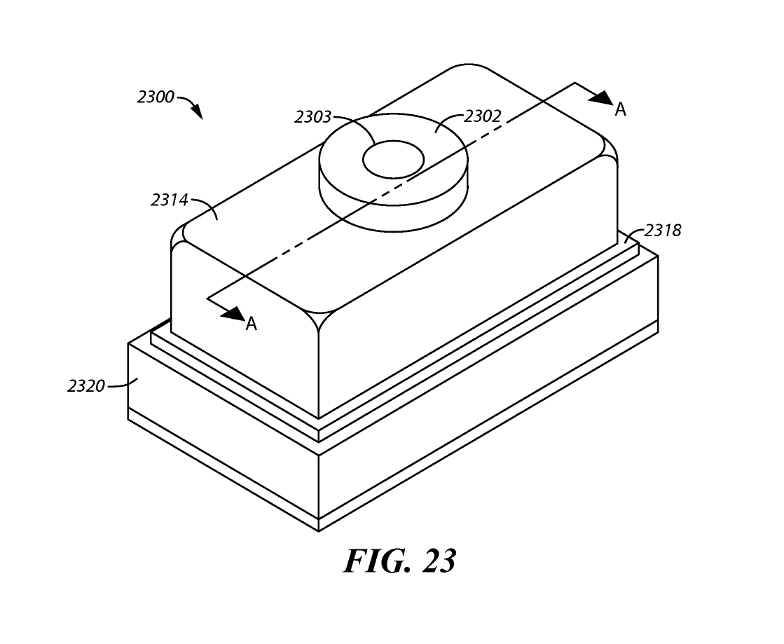

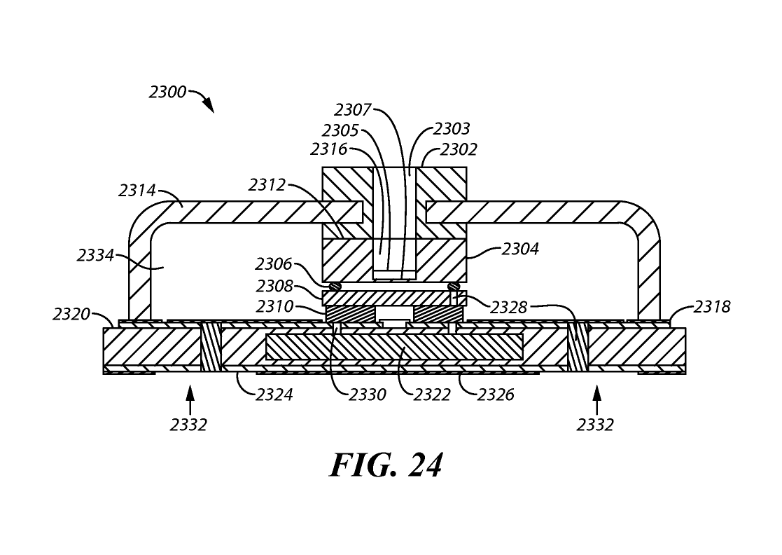

Referring now to FIGS. 23-24, another example of a microphone assembly 2300 is described. The microphone assembly 2300 includes a gasket 2302; a transducer 2304 (including a diaphragm 2305 and back plate 2307); bumps 2306 (e.g., constructed of gold); a pedestal 2308; solder 2310; adhesive 2312; a housing (e.g., a metal can) 2314 that includes a top port or opening 2303; a front volume 2316; an electrically conductive and acoustic seal 2318; a multi-layered base or substrate (e.g., PCB with embedded passives) 2320; an integrated circuit 2322; a solder pad 2324; a solder mask 2326; a filled plated through hole 2328; a plated blind hole 2330; conductive pads 2332; and back volume 2334.

It will be understood that the example of FIGS. 23-24 is similar to the example of FIGS. 11-12 but includes the pedestal of FIGS. 13-22 and that the integrated circuit 2322 is disposed within the base 2320. Since these components and the operation of these components are similar to what has already been described, this description will not be repeated here.

The assembly 2300 provides for very small assemblies (e.g., 2.5×2.5×3.0 mm or less). The assembly 2300 also provides a bottom port performance in a top port assembly (e.g., a top port metal can assembly).

It will be appreciated that the front volume is reduced compared to previous top port devices while the back volume is increased. This has the beneficial result of shifting the resonant peak by as much as 10 kHz, of the microphone assembly to higher frequencies and increasing overall sensitivity of the MEMS device. This allows for a top microphone that generates a flat response in the ultrasonic range that can be implemented in applications requiring wide band performance.

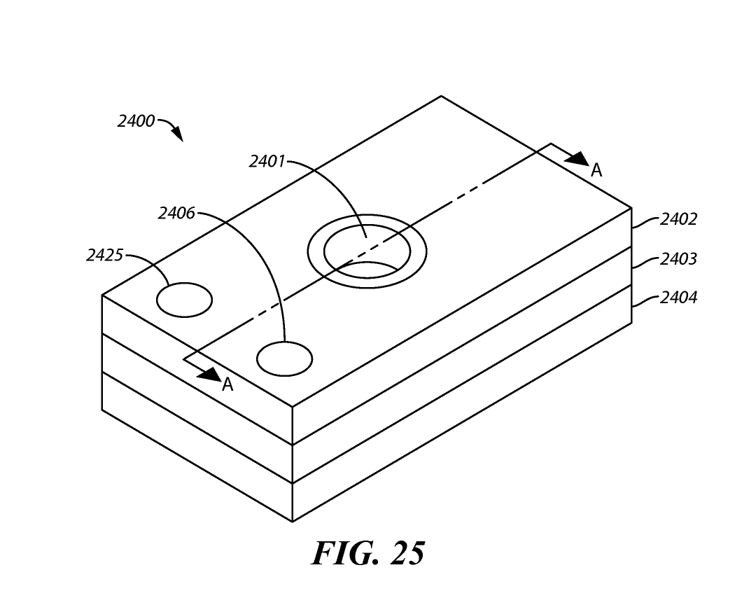

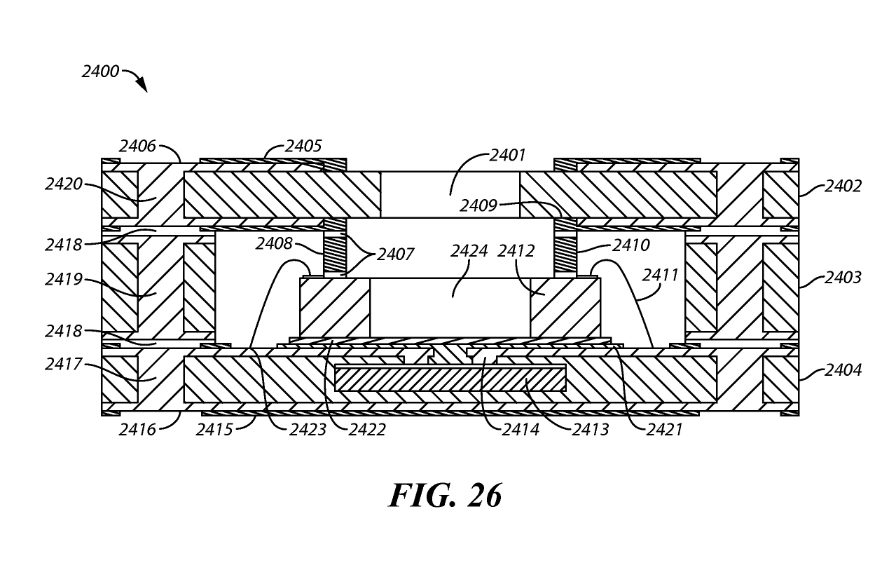

Referring now to FIGS. 25-26, another example of a microphone assembly 2400 is described. The microphone assembly 2400 includes a gasket 2410 with sealant 2407 that creates an acoustic port 2401 between the MEMs 2423 and lid 2402; a transducer 2412 attached to a base substrate 2404 using an adhesive 2422; a base substrate 2404 containing vertical interconnects 2417 that electrically connect an embedded ASIC 2413 to at least one bottom external interface 2416; a wall substrate 2403 containing vertical interconnects 2419 that are electrically connected with solder 2418 to the base 2404 and lid 2402, a lid 2402 containing vertical interconnects 2420 that electrically connects to the wall 2403 and top external interface 2406; two external interfaces 2406 and 2416 that are created by openings in passivations layers. The MEMs 2412 is affixed to the base 2404 with die attach adhesive 2411 which is dispensed on the passivation layer 2421, thereby creating a cavity 2424 forming the back volume. The MEMs 2412 is electrically connected to the embedded ASIC 2413 by gold wires 2411 that are bonded to wire bond pads 2423 that are electrically connected to the ASIC 2413 by plated blind vias 2414. It will be understood that this example is similar to previously mentioned examples with one difference being that a pedestal is not incorporated and the cover is comprised of a wall 2403 and lid 2402.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. An microphone assembly comprising:
a cover having an acoustic port;
a substrate attached to the cover;
an acoustic transducer acoustically sealed to the acoustic port of the cover;
an interposer;
such that the interposer and the acoustic transducer are electrically connected together without using the cover as an electrical conduit; and
such that the transducer and interposer are disposed one above the other and the transducer is supported by the interposer or by a pedestal.

2. The microphone assembly of claim 1 wherein the cover comprises a wall and lid.

3. The microphone assembly of claim 1 wherein the acoustic transducer comprises a Microelectromechanical system (MEMS) device.

4. The microphone assembly of claim 1 wherein the imposer is an element selected from the group consisting of an application specific integrated circuit (ASIC), an integrated circuit, and a ceramic plate.

5. The microphone assembly of claim 1 wherein the transducer is disposed upon bumps and the bumps are disposed on the interposer.

6. The microphone assembly of claim 5 wherein the bumps provide an electrical connection between the transducer and the interposer.

7. The microphone assembly of claim 1 wherein a wire bond couples the interposer to conductive traces on the substrate.

8. The microphone assembly of claim 1 further comprising an opening in the cover comprising an etched nozzle.

9. The microphone assembly of claim 1 further comprising an opening in the cover and a nozzle or tube disposed in the opening.

10. The microphone assembly of claim 1 further comprising an opening in the cover and a grommet or gasket disposed in the opening.

11. An microphone assembly comprising:
a lid having an acoustic port;
a substrate;
at least one wall disposed and between and attached to the lid and the substrate;
an acoustic transducer acoustically sealed to the acoustic port of the lid;
an integrated circuit embedded in the substrate;
such that the integrated circuit and the acoustic transducer are electrically connected without using the cover as an electrical conduit; and
such that the transducer and integrated circuit are disposed one above the other.

12. The microphone assembly of claim 11 wherein the acoustic transducer comprises a Microelectromechanical system (MEMS) device.
